(19) United States
(12) Patent Application Publication
(10) Pub. No.: US 2015/0229563 A1
(43) Pub. Date: Aug. 13, 2015

(54) PACKET FORWARDING METHOD AND NETWORK ACCESS DEVICE

(71) Applicant: Huawei Technologies Co., Ltd., Shenzhen (CN)

(72) Inventor: Cheng LUO, Wuhan (CN)

(21) Appl. No.: 14/618,684

(22) Filed: Feb. 10, 2015

(30) Foreign Application Priority Data
Feb. 11, 2014 (CN) 201410047794.7

(51) Int. Cl. H04L 12/741; H04L 12/931; H04L 29/06

(52) U.S. Cl. CPC H04L 45/74; H04L 69/22; H04L 49/70; H04L 69/08

(57) ABSTRACT

The present invention discloses a packet forwarding method and a network access device, where a forwarding module is added between WIFI controllers and USB controllers in an original architecture forwarding process. This module is implemented by hardware, has a forwarding entry, parses a packet according to a standard TCP/IP protocol, and then performs operations or actions such as editing, copying, discarding, and forwarding on the packet. Content of the forwarding entry is learnt by a Linux network protocol stack from an initial packet sent by the WIFI controller or the USB controller, and then a related rule is configured in the forwarding module; then, a subsequent packet from the WIFI controller or the USB controller is directly forwarded by the forwarding module. This packet forwarding method improves forwarding performance compared with the prior art.

### CROSS-REFERENCE TO RELATED APPLICATION

This application claims priority to Chinese Patent Application No. 201410047794.7, filed on Feb. 11, 2014, which is hereby incorporated by reference in its entirety.

### TECHNICAL FIELD

The present invention relates to the field of communications technologies, and in particular, to a packet forwarding method and a network access device.

### BACKGROUND

Currently, a USB (Universal Serial Bus, universal serial bus) is used to normalize a connection and communication between a computer and an external device, and is an interface technology applied to the PC (Personal Computer, personal computer) field. A USB interface supports a plug-and-play function and a hot-plugging function of a device, and a protocol standard has a USB1.0 (1.5 Mbps), USB1.1 (12 Mbps), USB2.0 (480 Mbps), USB3.0 (5 Gbps), and the like. With fast development of 3G networks, a network access data card, which typically implements network access by using the USB, has gradually become the first choice of business people and 3G operators to provide broadband services.

WIFI is a technology that can implement interconnection between terminals such as a personal computer and a handheld device (for example, a tablet computer and a mobile phone) in a wireless manner. A related protocol standard IEEE 802.11 is a universal standard for a current wireless local area network. It is a wireless network communication standard defined by the international Institute of Electrical and Electronic Engineers. The wireless communications protocol standard includes IEEE 802.11 (2 Mbps, working at 2.4 GHz), IEEE 802.11a (54 Mbps, working at 5 GHz), IEEE 802.11b (11 Mbps, working at 2.4 GHz), IEEE 802.11g (2 Mbps, working at 2.4 GHz), IEEE 802.11n (150 Mbps), IEEE 802.11ac (1 Gbps), and the like.

However, in a current HGW (Home GateWay, home gateway) scheme, regardless of USB or WIFI, data access is basically to run, on a CPU, a bottom-layer driver provided by a chip manufacturer of the CPU, so that a controller virtualized by using bottom-layer driver software performs control and processing on user access, protocol parsing, encryption and authentication, and data forwarding. For example, a USB controller implements link communication and control with a PC (or a peer Client (client) device) over a USB protocol, and converts a protocol packet sent by the PC into a standard TCP/IP protocol packet.

These controllers are all attached to a Linux network protocol stack, and perform protocol learning, control, and forwarding by using the network protocol stack.

For a basic structure of forwarding, refer to FIG. 1.

PC1: a device accessed by using a standard category 5 Ethernet cable, which may be a PC, a notebook computer, a switch, or the like.

PC2: a wireless access device, which may be a PC, a PAD, a mobile phone, or the like.

PC3: a device accessed by using a USB cable, which may be a network access data card, a PC, a mobile phone, a PDA, or the like.

The PC1 is accessed by using an Ethernet cable, and data sent by the PC1 is converted into a TCP/IP data packet by an ETH (Ethernet) controller. The PC2 is accessed in a wireless mode, and data sent by the PC2 is converted by a WIFI controller into a TCP/IP data packet by using the IEEE802.11x link protocol. The PC3 is accessed by using a USB cable, and data sent by the PC3 is converted by a USB controller into a TCP/IP data packet by using the USB link protocol. The Linux network protocol stack performs data control and forwarding on a packet between the controllers.

In this technical solution, the Linux network protocol stack is widely applied to a plurality of application scenarios, which causes that many CPU resources are consumed during parsing and processing. However, in the HGW gateway, hardware cost is extremely limited, only few memories are available and CPU processing performance is relatively low; in addition, CPU resources are not allowed to be occupied, and other gateway services also need to be processed. Therefore, this technology, when applied to a gateway device, presents a very obvious technical problem that network forwarding performance is poor. Nevertheless, forwarding performance is generally improved by optimizing software. Though this manner can improve the network forwarding performance to some degree within short time, the network forwarding performance will deteriorate again after working for a period of time due to service expansion, BUG amendment, and high memory consumption, and the network performance problem cannot be actually solved.

### SUMMARY

The present invention provides a packet forwarding method and a network access device to solve a technical problem in the prior art that network forwarding performance is poor.

According to a first aspect, a network access device is provided, where the network access device provides user-side interfaces of at least two protocols, including: a controller corresponding to a protocol type of a user-side interface of the network access device, a protocol processing module corresponding to a protocol type of a network-side interface of the network access device, a forwarding module, and a virtual device controller, where the forwarding module is a logical circuit; the controller is configured to perform protocol conversion on a packet sent by the user-side interface, and send a converted packet to the forwarding module; and perform protocol conversion on a packet sent by the forwarding module, and send a converted packet to the user-side interface; the forwarding module is configured to match a corresponding forwarding entry according to the packet sent by the controller, and forward the packet to an Ethernet user-side interface according to the matched forwarding entry; or match a corresponding forwarding entry according to a packet sent by an Ethernet user-side interface or the packet sent by the controller, encapsulate, according to the matched forwarding entry, the packet sent by the Ethernet user-side interface or the packet sent by the controller, and send an encapsulated packet to the virtual device controller; the virtual device controller is configured to forward, according to the encapsulation information of the packet sent by the forwarding module, the packet sent by the forwarding module to a corresponding controller or the protocol processing module; and the protocol processing module is configured to send the packet sent by the virtual device controller to the network-side interface.

With reference to the first aspect, in a first possible implementation manner, the forwarding module is specifically configured to modify a destination address of the packet sent by the controller.

With reference to the first aspect, in a second possible implementation manner, the forwarding module is specifically configured to: if the corresponding forwarding entry is not matched, forward the packet sent by the controller to the virtual device controller, so that the virtual device controller forwards the packet and delivers the forwarding entry corresponding to the packet to the forwarding module.

With reference to the first aspect, in a third possible implementation manner, the controller includes a first controller, where the first controller is connected to a user-side interface of a first protocol, and the first protocol is a USB protocol or a wireless communications protocol; the forwarding module is specifically configured to: after an Ethernet packet, which is sent to a user equipment connected to the user-side interface of the first protocol, is received from the Ethernet user-side interface, match a corresponding forwarding entry according to the Ethernet packet, update a destination address of the Ethernet packet to an address of the first controller according to the matched forwarding entry, and forward the Ethernet packet with the destination address updated to the virtual device controller; the virtual device controller is specifically configured to forward the Ethernet packet with the destination address updated to the first controller; and the first controller is specifically configured to convert the Ethernet packet with the destination address updated into a first protocol packet, and send, through the user-side interface of the first protocol, the first protocol packet to the user equipment connected to the user-side interface of the first protocol.

With reference to the first aspect, in a fourth possible implementation manner, the controller includes a first controller, where the first controller is connected to a user-side interface of a first protocol, and the first protocol is a USB protocol or a wireless communications protocol; the first controller is specifically configured to perform Ethernet protocol conversion on a packet sent by the user-side interface of the first protocol, and send a converted packet to the forwarding module; and the forwarding module is specifically configured to match a corresponding forwarding entry according to an Ethernet packet sent by the first controller, and when the Ethernet user-side interface is matched, send the Ethernet packet sent by the first controller to the Ethernet user-side interface according to the matched forwarding entry.

With reference to the first aspect, in a fifth possible implementation manner, the controller includes a first controller and a second controller, where the first controller is connected to a user-side interface of a first protocol, and the second controller is connected to a user-side interface of a second protocol; and the first protocol is a USB protocol, and the second protocol is a wireless communications protocol, or the first protocol is a wireless communications protocol, and the second protocol is a USB protocol; the first controller is specifically configured to perform Ethernet protocol conversion on a packet sent by the user-side interface of the first protocol, and send a converted packet to the forwarding module; the forwarding module is specifically configured to match a corresponding forwarding entry according to an Ethernet packet sent by the first controller, and encapsulate, according to the matched forwarding entry, the Ethernet packet sent by the first controller, and send an encapsulated Ethernet packet to the virtual device controller; the virtual device controller is specifically configured to receive encapsulation information of the Ethernet packet sent by the forwarding module, and forward the Ethernet packet sent by the forwarding module to the second controller; and the second controller is specifically configured to perform protocol conversion on the Ethernet packet sent by the virtual device controller, and send a converted packet to the user-side interface of the second protocol.

With reference to the first aspect, the first possible implementation manner, the second possible implementation manner, the third possible implementation manner, the fourth possible implementation manner, and the fifth possible implementation manner, in a sixth possible implementation manner, the controller and the forwarding module communicate by using an Ethernet protocol or a proprietary protocol; and the forwarding module and the virtual controller communicate by using the Ethernet protocol.

With reference to the first aspect, the first possible implementation manner, the second possible implementation manner, the third possible implementation manner, the fourth possible implementation manner, the fifth possible implementation manner, and the sixth possible implementation manner, in a seventh possible implementation manner, the controller is a virtual controller, or the controller is a logical circuit.

According to a second aspect, a network access device is provided and applied to a network access device, where the network access device provides user-side interfaces of at least two protocols and includes: a controller corresponding to a protocol type of a user-side interface of the network access device, a protocol processing module corresponding to a protocol type of a network-side interface of the network access device, a forwarding module, and a virtual device controller, where the forwarding module is a logical circuit; and the method includes: performing, by the controller, protocol conversion on a packet sent by the user-side interface, and sending a converted packet to the forwarding module; and performing protocol conversion on a packet sent by the forwarding module, and sending a converted packet to the user-side interface; matching, by the forwarding module, a corresponding forwarding entry according to the packet sent by the controller, and forwarding the packet to an Ethernet user-side interface according to the matched forwarding entry; or matching a corresponding forwarding entry according to a packet sent by an Ethernet user-side interface or the packet sent by the controller, encapsulating, according to the matched forwarding entry, the packet sent by the Ethernet user-side interface or the packet sent by the controller, and sending an encapsulated packet to the virtual device controller; forwarding, by the virtual device controller, according to encapsulation information of the packet sent by the forwarding module, the packet sent by the forwarding module to a corresponding controller or the protocol processing module; and sending, by the protocol processing module, the packet sent by the virtual device controller to the network-side interface.

With reference to the second aspect, in a first possible implementation manner, the encapsulating, according to the matched forwarding entry, the packet sent by the controller is specifically as follows: modifying, by the forwarding module, a destination address of the packet sent by the controller.

With reference to the second aspect, in a second possible implementation manner, the method further includes: if the corresponding forwarding entry is not matched, forwarding, by the forwarding module, the packet sent by the controller to the virtual device controller, so that the virtual device controller forwards the packet and delivers the forwarding entry corresponding to the packet to the forwarding module.

With reference to the second aspect, in a third possible implementation manner, the controller includes a first controller, where the first controller is connected to a user-side interface of a first protocol, and the first protocol is a USB protocol or a wireless communications protocol; and the method further includes: after receiving, from the Ethernet user-side interface, an Ethernet packet, which is sent to a user equipment connected to the user-side interface of the first protocol, matching, by the forwarding module, a corresponding forwarding entry according to the Ethernet packet, updating a destination address of the Ethernet packet to an address of the first controller according to the matched forwarding entry, and forwarding the Ethernet packet with the destination address updated to the virtual device controller; forwarding, by the virtual device controller, the Ethernet packet with the destination address updated to the first controller; and converting, by the first controller, the Ethernet packet with the destination address into a first protocol packet, and sending, through the user-side interface of the first protocol, the first protocol packet to the user equipment connected to the user-side interface of the first protocol.

With reference to the second aspect, in a fourth possible implementation manner, the controller includes a first controller, where the first controller is connected to a user-side interface of a first protocol, and the first protocol is a USB protocol or a wireless communications protocol; and the method further includes: performing, by the first controller, Ethernet protocol conversion on a packet sent by the user-side interface of the first protocol, and sending a converted packet to the forwarding module; and matching, by the forwarding module, a corresponding forwarding entry according to an Ethernet packet sent by the first controller, and when the Ethernet user-side interface is matched, sending the Ethernet packet sent by the first controller to the Ethernet user-side interface according to the matched forwarding entry.

With reference to the second aspect, in a fifth possible implementation manner, the controller includes a first controller and a second controller, where the first controller is connected to a user-side interface of a first protocol, and the second controller is connected to a user-side interface of a second protocol; and the first protocol is a USB protocol, and the second protocol is a wireless communications protocol, or the first protocol is a wireless communications protocol, and the second protocol is a USB protocol; and the method further includes: performing, by the first controller, Ethernet protocol conversion on a packet sent by the user-side interface of the first protocol, and sending a converted packet to the forwarding module; matching, by the forwarding module, a corresponding forwarding entry according to an Ethernet packet sent by the first controller, and encapsulating, according to the matched forwarding entry, the Ethernet packet sent by the first controller, and sending an encapsulated Ethernet packet to the virtual device controller; receiving, by the virtual device controller, encapsulation information of the Ethernet packet sent by the forwarding module, and forwarding the Ethernet packet sent by the forwarding module to the second controller; and performing, by the second controller, protocol conversion on the Ethernet packet sent by the virtual device controller, and sending a converted packet to the user-side interface of the second protocol.

With reference to the second aspect, the first possible implementation manner, the second possible implementation manner, the third possible implementation manner, the fourth possible implementation manner, and the fifth possible implementation manner, in a sixth possible implementation manner, the controller and the forwarding module communicate by using an Ethernet protocol or a proprietary protocol; and the forwarding module and the virtual controller communicate by using the Ethernet protocol.

With reference to the second aspect, the first possible implementation manner, the second possible implementation manner, the third possible implementation manner, the fourth possible implementation manner, the fifth possible implementation manner, and the sixth possible implementation manner, in a seventh possible implementation manner, the controller is a virtual controller, or the controller is a logical circuit.

One or multiple technical solutions of the foregoing technical solutions have the following technical effects or advantages:

In the present invention, a forwarding module is added between WIFI controllers or between USB controllers in an original architecture forwarding process. This module is implemented by hardware, has a forwarding entry, parses a packet according to a standard TCP/IP protocol, and then performs operations or actions such as editing, copying, discarding, and forwarding on the packet. Content of the forwarding entry is learnt by a Linux network protocol stack from an initial packet sent by the WIFI controller or the USB controller, and then a related rule is configured in the forwarding module; then, a subsequent packet from the WIFI controller or the USB controller is directly forwarded by the forwarding module. This packet forwarding method improves forwarding performance compared with the prior art.

Further, a packet sent from the controller to the Ethernet can be directly forwarded by the forwarding module to an Ethernet port, thereby reducing resources consumed by a CPU in parsing a packet, and improving forwarding efficiency. Similarly, for a packet sent from the Ethernet to the controller, the forwarding module obtains egress destination device information, completes encapsulation of a related packet, and then sends an encapsulated packet to the virtual device controller; after extracting the packet, the virtual device controller sends the packet to the controller directly according to the egress destination device information. In this way, the CPU does not need to parse and process the packet, which also optimizes the original forwarding process greatly and achieves a purpose of fast forwarding.

### BRIEF DESCRIPTION OF DRAWINGS

FIG. 1 is a basic structural diagram of forwarding system in the prior art;

FIG. 2A is a schematic diagram of an application scenario of a network access device according to an embodiment of the present invention;

FIG. 2B is schematic structural diagram of a network access device according to an embodiment of the present invention;

FIG. 3 is a basic structural diagram of packet protocol identification and packet forwarding according to an embodiment of the present invention;

FIG. 4 is a structural diagram of forwarding a packet from the Ethernet to a USB controller/a WIFI controller according to an embodiment of the present invention;

FIG. 5 is a structural diagram of forwarding a packet from a USB controller/a WIFI controller to the Ethernet according to an embodiment of the present invention;

FIG. 6 is a structural diagram of forwarding a packet from a USB controller to a WIFI controller according to an embodiment of the present invention;

FIG. 7 is a structural diagram of forwarding a packet by using a proprietary protocol according to an embodiment of the present invention; and

FIG. 8 is a process diagram of a packet forwarding method according to an embodiment of the present invention.

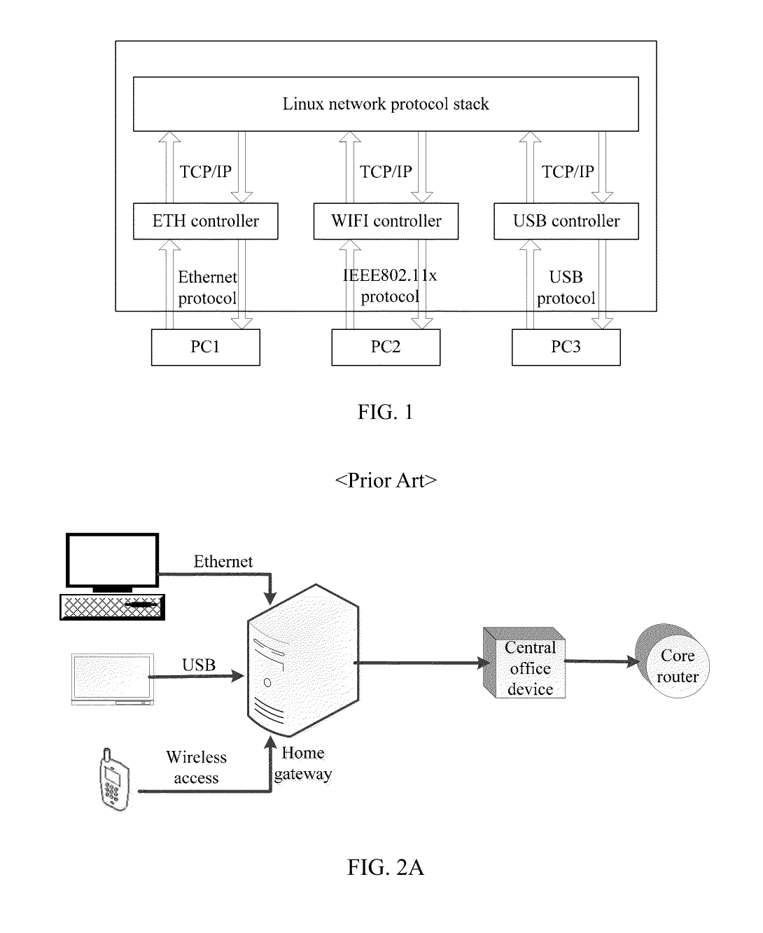

### DESCRIPTION OF EMBODIMENTS

To solve a technical problem in the prior art that network forwarding performance is poor, embodiments of the present invention provide a packet forwarding method and a network access device. The following describes the technical solutions of the present invention in detail with reference to the accompanying drawings and specific embodiments. In the present invention, a forwarding module is added between WIFI controllers or between USB controllers in an original architecture forwarding process. This module is implemented by hardware, has a forwarding entry, parses a packet according to a standard TCP/IP protocol, and then performs operations or actions such as editing, copying, discarding, and forwarding on the packet. Content of the forwarding entry is learnt by a Linux network protocol stack from an initial packet sent by the WIFI controller or the USB controller, and then a related rule is configured in the forwarding module; then, a subsequent packet from the WIFI controller or the USB controller is directly forwarded by the forwarding module, so that very high forwarding performance is achieved. It should be understood that the embodiments of the present invention and specific features in the embodiments are detailed descriptions of the technical solutions of the present invention rather than limitations on the technical solutions of the present invention. In case in which there is no conflict, the embodiments of the present invention and the technical features in the embodiments may be mutually combined.

### Embodiment 1

In this embodiment of the present invention, a network access device is described.

In a specific implementation process, the network access device includes but is not limited to an HGW. The network access device provides user-side interfaces of at least two protocols, and the user-side interfaces are configured to accept a plug-in connection of an electronic device such as a PC or a mobile phone. The protocols include but are not limited to a USB protocol, the IEEE802.11x protocol, or an Ethernet protocol, or the like.

The following describes an application scenario of the network access device by taking a home gateway as an example.

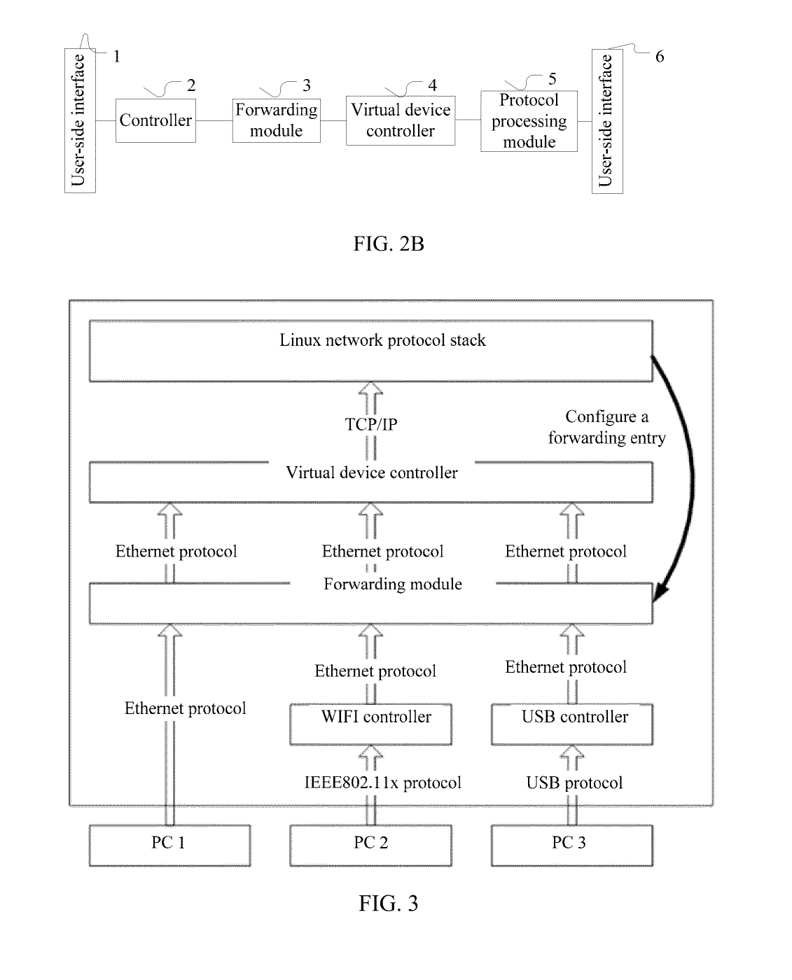

Refer to FIG. 2A. A home gateway is downlink connected to various electronic devices such as a desktop computer, a notebook computer, and a tablet computer. The home gateway is uplink connected to a plurality of service gateways, such as ADSL (Asymmetric Digital Subscriber Line, asymmetric digital subscriber line), VDSL (Very-high-bit-rate Digital Subscriber Line), EPON (Ethernet Passive Optical Network, Ethernet Passive Optical Network), ETH, PLC (Programmable Logic Controller, programmable logic controller), and LTE (Long Term Evolution, long term evolution) service gateways, and then is connected to a metropolitan area network by a central office device, and is finally connected to a backbone network by a core router, so as to provide high-quality network services for a home terminal user.

Refer to FIG. 2B. The network access device specifically includes: a controller 2 corresponding to a protocol type of a user-side interface 1 of the network access device, a protocol processing module 5 corresponding to a protocol type of a network-side interface 6 of the network access device, a forwarding module 3, and a virtual device controller 4. The forwarding module 3 is a logical circuit.

The user-side interface of the network access device may include user-side interfaces of at least two protocols. Accordingly, a controller corresponds to a protocol type of the user-side interface. For example, if the user-side interface includes an Ethernet interface, a USB interface, and a WIFI interface, the controller may include an ETH controller (Ethernet controller) corresponding to the Ethernet interface, a WIFI controller corresponding to the WIFI interface, and a USB controller corresponding to the USB interface. The protocol processing module is related to a protocol type used by the network-side interface, and is mainly configured to communicate with an external network.

The following specifically describes functions of each of the functional modules.

The controller 2 is configured to perform protocol conversion on a packet sent by the user-side interface 1, and send a converted packet to the forwarding module 3; and perform protocol conversion on a packet sent by the forwarding module 3, and send a converted packet to the user-side interface 1. In a specific implementation process, the present invention involves multiple protocol types, for example, a USB protocol, the IEEE802.11x protocol, or an Ethernet protocol. Therefore, the controller 2 may be of different types according to different protocol types. For example, if a protocol is the USB protocol, the controller is a USB controller; if a protocol is the IEEE802.11x protocol, the controller 2 is a WIFI controller.

The forwarding module 3 is configured to match a corresponding forwarding entry according to the packet sent by the controller 2, and forward the packet to an Ethernet user-side interface according to the matched forwarding entry; or match a corresponding forwarding entry according to a packet sent by an Ethernet user-side interface or the packet sent by the controller 2, encapsulate, according to the matched forwarding entry, the packet sent by the Ethernet user-side interface or the packet sent by the controller 2, and send an encapsulated packet to the virtual device controller 4. In a specific implementation process, the forwarding module 3 is implemented by hardware, has a forwarding entry, and performs packet encapsulation according to the forwarding entry by using a standard TCP/IP protocol. In another embodiment of the present invention, the forwarding module 3 is specifically configured to modify a destination address of the packet sent by the controller 2. In another embodiment of the present invention, if the corresponding forwarding entry is not matched, the forwarding module 3 is specifically configured to forward the packet sent by the controller 2 to the virtual device controller 4, so that the virtual device controller 4 forwards the packet and delivers the forwarding entry corresponding to the packet to the forwarding module 3.

The virtual device controller 4 is configured to forward, according to encapsulation information of the packet sent by the forwarding module 3, the packet sent by the forwarding module 3 to a corresponding controller 2 or the protocol processing module 5.

The protocol processing module 5 is configured to send the packet sent by the virtual device controller to the network-side interface 6, and then the network-side interface 6 forwards the packet to a Linux network protocol stack.

Referring to FIG. 3, FIG. 3 is a basic structural diagram of packet protocol identification and forwarding. A PC1 at a user side is accessed by using an Ethernet cable, a PC2 is accessed in a wireless mode, and a PC3 is accessed by using a USB cable. A WIFI controller and a USB controller are implemented by a standard device driver provided by a related chip manufacturer, connected between a corresponding user-side interface and a forwarding module, and are responsible for performing protocol conversion and packet receiving and sending. This type of protocol conversion and packet receiving and sending is bidirectional. A packet received from a PC end passes through the forwarding module and a virtual device controller, and is finally converted into a TCP/IP packet that can be identified by a Linux network protocol stack and is stored into an SKB memory block. On the contrary, the Linux network protocol stack then converts the received TCP/IP packet into an Ethernet packet, and transfers the Ethernet packet to the forwarding module. The forwarding module performs matching in a forwarding entry according to a TCP/IP packet format; if the matching succeeds, the forwarding module performs editing/forwarding according to an entry rule. If the packet is an initial packet, the forwarding entry is empty, and thus the matching fails. If the corresponding forwarding entry is not matched, the forwarding module forwards a related packet to the virtual device controller. The virtual device controller converts the packet into a standard TCP/IP packet, and transfers the TCP/IP packet to the Linux network protocol stack. The virtual device controller mainly completes reading the related packet from the forwarding module, parsing the packet, and then transferring the packet to the Linux network protocol stack. After completing parsing the packet, the Linux network protocol stack performs forwarding, and an internal adaption module delivers a forwarding entry according to a forwarding entry format.

There are multiple manners of matching, parsing, or searching according to the forwarding entry, for example, quick searching may be implemented by selecting a quintet matching HASH algorithm or large entry traversal matching. The packet is parsed according to a standard TCP/IP Ethernet protocol, and a critical control field in the header is matched. It can be supported that range matching and accurate matching are performed on such fields as a source MAC, a destination MAC, a protocol type, a TOS, a COS, a VLAN, an IP, a port, an TCP ACK, or an IP Option.

In another embodiment of the present invention, the controller includes a first controller; the first controller is connected to a user-side interface of a first protocol; the first protocol is a communications protocol except the Ethernet protocol; and the first protocol is a USB protocol or a wireless communications protocol.

The forwarding module is specifically configured to: after an Ethernet packet, which is sent to a user equipment connected to the user-side interface of the first protocol, is received from the Ethernet user-side interface, match a corresponding forwarding entry according to the Ethernet packet, update a destination address of the Ethernet packet to an address of the first controller according to the matched forwarding entry, and forward the Ethernet packet with the destination address updated to the virtual device controller.

The virtual device controller is specifically configured to forward the Ethernet packet with the destination address updated to the first controller.

The first controller is specifically configured to convert the Ethernet packet with the destination address updated into a first protocol packet, and send, through the user-side interface of the first protocol, the first protocol packet to the user equipment connected to the user-side interface of the first protocol.

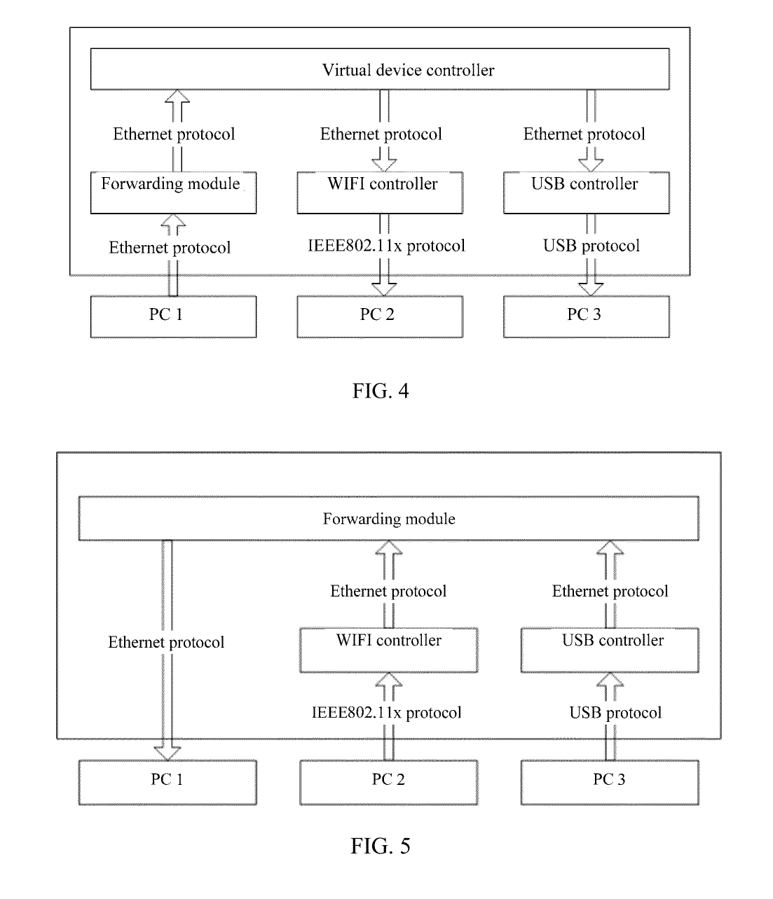

Refer to FIG. 4. A structural diagram of forwarding a packet from the Ethernet to a USB controller/a WIFI controller is described.

In a specific implementation process, a PC1 at a user side is accessed by using an Ethernet cable, a PC2 is accessed in a wireless mode, and a PC3 is accessed by using a USB cable. The first controller is specifically a USB controller connected to a user-side interface of a USB protocol, or a WIFI controller connected to a user-side interface of a wireless communications protocol.

First, the PC1 sends an Ethernet packet, where the Ethernet packet is specifically sent to the PC3 connected to a user-side interface of the USB protocol.

After a forwarding module receives the Ethernet packet, the forwarding module matches a corresponding forwarding entry according to the Ethernet packet, updates, according to the matched forwarding entry, a destination address of the Ethernet packet to an address of the USB controller, and forwards the Ethernet packet with the destination address updated to a virtual device controller.

The virtual device controller forwards the Ethernet packet with the destination address updated to the USB controller.

The USB controller converts the Ethernet packet with the destination address updated into a USB protocol packet, and sends the USB protocol packet to the PC3 through the user-side interface of the USB protocol.

If the Ethernet packet sent by the PC1 is sent to the PC2 connected to a user-side interface of a WIFI protocol, when updating a destination address of the Ethernet packet, the forwarding module updates the destination address of the Ethernet packet to an address of the WIFI controller, and then forwards the Ethernet packet with the destination address updated to a virtual device controller. The virtual device controller sends the Ethernet packet to the WIFI controller. The WIFI controller further converts the Ethernet packet with the destination address updated into an IEEE 802.11X protocol packet, and then sends the IEEE 802.11X packet to the PC2 through a user-side interface of the WIFI protocol.

In the foregoing sending process, hardware is used for forwarding, which greatly improves forwarding efficiency, reduces CPU resource occupation, and reduces memory required by software compared with an original process in which software is used for parsing and forwarding, thereby achieving a purpose of fast forwarding with low costs.

In another embodiment of the present invention, the controller includes a first controller, where the first controller is connected to a user-side interface of a first protocol; and the first protocol is a USB protocol or a wireless communications protocol.

The first controller is specifically configured to perform Ethernet protocol conversion on a packet sent by the user-side interface of the first protocol, and send a converted packet to the forwarding module. The forwarding module is specifically configured to match a corresponding forwarding entry according to an Ethernet packet sent by the first controller, and when the Ethernet user-side interface is matched, send, according to the matched forwarding entry, the Ethernet packet sent by the first controller to the Ethernet user-side interface.

Refer to FIG. 5. A structural diagram of forwarding a packet from a USB controller/a WIFI controller to the Ethernet is described.

In a specific implementation process, a PC1 at a user side is accessed by using an Ethernet cable, a PC2 is accessed in a wireless mode, and a PC3 is accessed by using a USB cable. The first controller is specifically a USB controller connected to a user-side interface of a USB protocol, or a WIFI controller connected to a user-side interface of a wireless communications protocol.

It is assumed that the PC3 sends a packet. The PC3 sends a USB protocol packet to the USB controller through a user-side interface. The USB controller performs Ethernet protocol conversion on the USB protocol packet sent by the user-side interface, and sends a converted packet to a forwarding module. The forwarding module matches a corresponding forwarding entry according to the Ethernet packet sent by the USB controller, and sends, according to the matched forwarding entry, the Ethernet packet sent by the USB controller to the PC1.

It is assumed that the PC2 sends a packet. The PC2 sends a wireless communications protocol packet to the WIFI controller through a user-side interface. The WIFI controller performs Ethernet protocol conversion on the wireless communications protocol packet sent by the user-side interface, and sends a converted packet to a forwarding module. The forwarding module matches a corresponding forwarding entry according to the Ethernet packet sent by the WIFI controller, and sends, according to the matched forwarding entry, the Ethernet packet sent by the WIFI controller to the PC1.

In another embodiment of the present invention, the controller includes a first controller and a second controller, where the first controller is connected to a user-side interface of a first protocol, and the second controller is connected to a user-side interface of a second protocol; and the first protocol is a USB protocol, and the second protocol is a wireless communications protocol, or the first protocol is a wireless communications protocol, and the second protocol is a USB protocol.

The first controller is specifically configured to perform Ethernet protocol conversion on a packet sent by the user-side interface of the first protocol, and send a converted packet to the forwarding module.

The forwarding module is specifically configured to match a corresponding forwarding entry according to the Ethernet packet sent by the first controller, and encapsulate, according to the matched forwarding entry, the Ethernet packet sent by the first controller, and send an encapsulated Ethernet packet to the virtual device controller.

The virtual device controller is specifically configured to receive encapsulation information of the Ethernet packet sent by the forwarding module, and forward the Ethernet packet sent by the forwarding module to the second controller.

The second controller is specifically configured to perform protocol conversion on the Ethernet packet sent by the virtual device controller, and send a converted packet to the user-side interface of the second protocol.

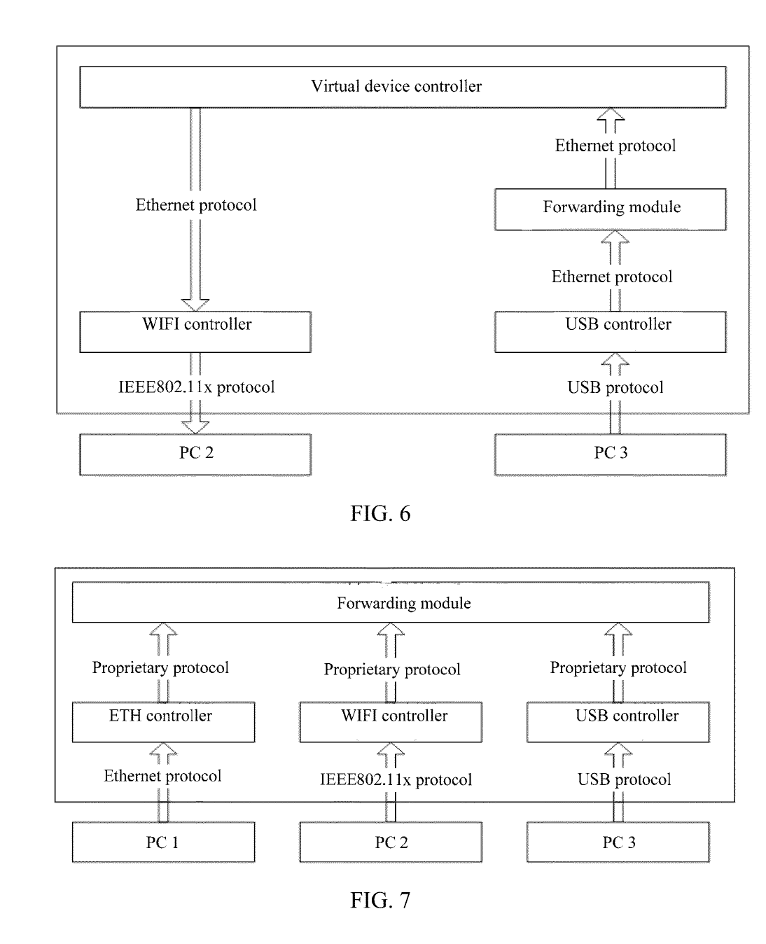

Refer to FIG. 6. A structural diagram of forwarding a packet from a USB controller to a WIFI controller is described.

In a specific implementation process, a PC1 at a user side is accessed by using an Ethernet cable, a PC2 is accessed in a wireless mode, and a PC3 is accessed by using a USB cable. If a first protocol is a USB protocol and a second protocol is a wireless communications protocol, a first controller is specifically a USB controller connected to a user-side interface of the USB protocol, and a second controller is specifically a WIFI controller connected to a user-side interface of the wireless communications protocol.

The PC3 sends a packet to the PC2. First, the USB controller parses the USB protocol, converts it into an Ethernet protocol, and transfers the Ethernet protocol to a forwarding module; the forwarding module searches a configured forwarding entry, and knows by matching that the packet needs to be sent to the PC2; the forwarding module configures and edits the packet according to the entry, and then transfers the packet to a virtual device controller; the virtual device controller extracts the packet, and invokes a WIFI controller transmission interface; and the WIFI controller sends the packet to the PC2.

In another embodiment of the present invention, the controller and the forwarding module communicate by using the Ethernet protocol or a proprietary protocol; and the forwarding module and the virtual controller communicate by using the Ethernet protocol. The proprietary protocol is used as an example. Refer to FIG. 7. A structural diagram of forwarding a packet by using the proprietary protocol is described. In a specific implementation process, a PC1 is accessed by using an Ethernet cable, and a packet is converted into a proprietary protocol packet by an ETH controller. A PC2 is accessed in a wireless mode, and a packet is converted by a WIFI controller into a proprietary protocol packet by using the IEEE802.11x link protocol. A PC3 is accessed by using a USB cable, and a packet is converted by a USB controller into a proprietary protocol packet by using a USB link protocol.

In another embodiment of the present invention, the controller is a virtual controller, that is, the controller is a controller virtualized by using bottom-layer driver software; or the controller is a logical circuit, that is, the ETH controller, the WIFI controller, and the USB controller may also be implemented by hardware only.

In another embodiment of the present invention, a packet forwarding method is described.

In a specific implementation process, the method is applied to a network access device, where the network access device includes but is not limited to an HGW. The network access device provides user-side interfaces of at least two protocols. In a specific implementation process, a specific structure of the network access device is shown in FIG. 2; the network access device includes a controller corresponding to a protocol type of a user-side interface of the network access device, a protocol processing module corresponding to a protocol type of a network-side interface of the network access device, a forwarding module, and a virtual device controller. Specifically, the forwarding module is implemented by hardware such as a logical circuit.

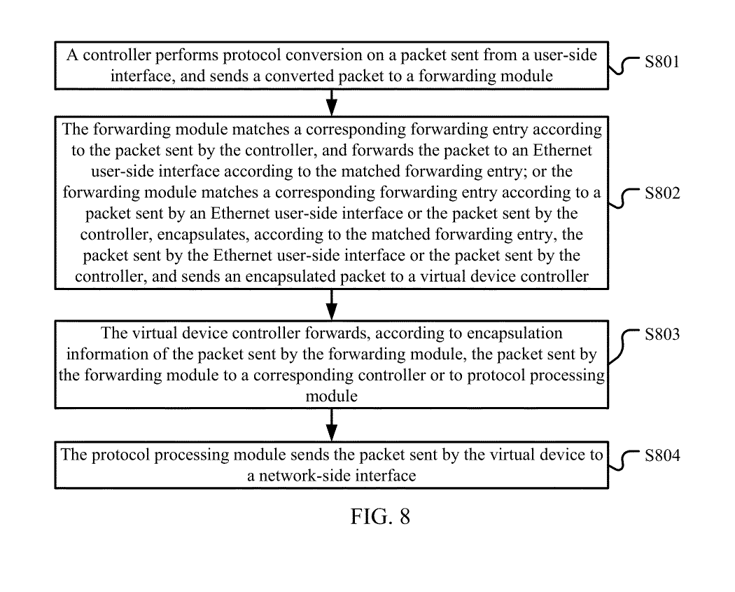

Refer to FIG. 8. The packet forwarding method of the present invention specifically includes:

S801. The controller performs protocol conversion on a packet sent from a user-side interface, and sends a converted packet to the forwarding module.

In a specific implementation process, the user-side interface is used to accept a plug-in connection of an electronic device such as a PC and a mobile phone. The protocols include but are not limited to a USB protocol, the IEEE802.11x protocol, or an Ethernet protocol, or the like. Therefore, the controller may be of different types according to different protocol types, for example, if a protocol is the USB protocol, the controller is a USB controller; if a protocol is the IEEE802.11x protocol, the controller is a WIFI controller. In addition, the controller further performs protocol conversion on a packet sent by the forwarding module, and sends a converted packet to the user-side interface.

S802. The forwarding module matches a corresponding forwarding entry according to the packet sent by the controller, and forwards the packet to an Ethernet user-side interface according to the matched forwarding entry; or the forwarding module matches a corresponding forwarding entry according to a packet sent by an Ethernet user-side interface or the packet sent by the controller, encapsulates, according to the matched forwarding entry, the packet sent by the Ethernet user-side interface or the packet sent by the controller, and sends an encapsulated packet to the virtual device controller.

In a specific implementation process, the forwarding module is implemented by hardware, has a forwarding entry, and performs packet encapsulation according to the forwarding entry by using a standard TCP/IP protocol. During encapsulation, the forwarding module modifies a destination address of the packet sent by the controller. In another embodiment of the present invention, if the corresponding forwarding entry is not matched, the forwarding module forwards the packet sent by the controller to the virtual device controller, so that the virtual device controller forwards the packet and delivers a forwarding entry corresponding to the packet to the forwarding module.

S803. The virtual device controller forwards, according to encapsulation information of the packet sent by the forwarding module, the packet sent by the forwarding module to a corresponding controller or the protocol processing module.

S804. The protocol processing module sends the packet sent by the virtual device controller to a network-side interface.

The network-side interface further forwards the packet to a Linux network protocol stack.

The foregoing process is a basis for packet forwarding. In a specific forwarding process, the following several packet forwarding manners are available.

The first packet forwarding manner is that a PC1 connected to an Ethernet user-side interface sends a packet to a terminal connected to the controller.

The controller includes a first controller, where the first controller is connected to a user-side interface of a first protocol; and the first protocol is a USB protocol or a wireless communications protocol.

The packet forwarding method specifically includes:

after receiving, from the Ethernet user-side interface, an Ethernet packet, which is sent to a user equipment connected to the user-side interface of the first protocol, matching, by the forwarding module, a corresponding forwarding entry according to the Ethernet packet, updating a destination address of the Ethernet packet to an address of the first controller according to the matched forwarding entry, and forwarding the Ethernet packet with the destination address updated to the virtual device controller;

forwarding, by the virtual device controller, the Ethernet packet with the destination address updated to the first controller; and

converting, by the first controller, the Ethernet packet with the destination address updated into a first protocol packet, and sending, through the user-side interface of the first protocol, the first protocol packet to the user equipment connected to the user-side interface of the first protocol.

For a specific implementation process, reference may be made to FIG. 4, where a PC1 is accessed by using an Ethernet cable, a PC2 is accessed in a wireless mode, and a PC3 is accessed by using a USB cable. The first controller is specifically a USB controller connected to a user-side interface of a USB protocol, or a WIFI controller connected to a user-side interface of a wireless communications protocol.

First, the PC1 sends an Ethernet packet, where the Ethernet packet is specifically sent to the PC3 connected to a user-side interface of the USB protocol.

After a forwarding module receives the Ethernet packet, the forwarding module matches a corresponding forwarding entry according to the Ethernet packet, updates, according to the matched forwarding entry, a destination address of the Ethernet packet to an address of the USB controller, and forwards the Ethernet packet with the destination address updated to a virtual device controller.

The virtual device controller forwards the Ethernet packet with the destination address updated to the USB controller.

The USB controller converts the Ethernet packet with the destination address updated into a USB protocol packet, and sends the USB protocol packet to the PC3 through the user-side interface of the USB protocol.

If the Ethernet packet sent by the PC1 is sent to the PC2 connected to a user-side interface of a WIFI protocol, when updating a destination address of the Ethernet packet, the forwarding module updates the destination address of the Ethernet packet to an address of the WIFI controller, and then forwards the Ethernet packet with the destination address updated to a virtual device controller. The virtual device controller sends the Ethernet packet to the WIFI controller. The WIFI controller further converts the Ethernet packet with the destination address updated into an IEEE 802.11X protocol packet, and then sends the IEEE 802.11X packet to the PC2 through a user-side interface of the WIFI protocol.

In the foregoing sending process, hardware is used for forwarding, which greatly improves forwarding efficiency, reduces CPU resource occupation, and reduces memory required by software compared with an original process in which software is used for parsing and forwarding, thereby achieving a purpose of fast forwarding with low costs.

The second packet forwarding manner is an implementation process of forwarding a packet to the Ethernet by a controller. The controller includes a first controller, where the first controller is connected to a user-side interface of a first protocol; and the first protocol is a USB protocol or a wireless communications protocol. The packet forwarding method includes:

performing, by the first controller, Ethernet protocol conversion on a packet sent by the user-side interface of the first protocol, and sending a converted packet to the forwarding module; and

matching, by the forwarding module, a corresponding forwarding entry according to an Ethernet packet sent by the first controller, and when the Ethernet user-side interface is matched, sending the Ethernet packet sent by the first controller to the Ethernet user-side interface according to the matched forwarding entry.

Refer to FIG. 5. A structural diagram of forwarding a packet from USB/WIFI to the Ethernet is described.

In a specific implementation process, a PC1 is accessed by using an Ethernet cable, a PC2 is accessed in a wireless mode, and a PC3 is accessed by using a USB cable. The first controller is specifically a USB controller connected to a user-side interface of a USB protocol, or a WIFI controller connected to a user-side interface of a wireless communications protocol.

It is assumed that the PC3 sends a packet. The PC3 sends a USB protocol packet to the USB controller through a user-side interface. The USB controller performs Ethernet protocol conversion on the USB protocol packet sent by the user-side interface, and sends a converted packet to a forwarding module. The forwarding module matches a corresponding forwarding entry according to the Ethernet packet sent by the USB controller, and sends the Ethernet packet sent by the USB controller to the PC1 according to the matched forwarding entry.

It is assumed that the PC2 sends a packet. The PC2 sends a wireless communications protocol packet to the WIFI controller through a user-side interface. The WIFI controller performs Ethernet protocol conversion on the wireless communications protocol packet sent by the user-side interface, and sends a converted packet to a forwarding module. The forwarding module matches a corresponding forwarding entry according to the Ethernet packet sent by the WIFI controller, and sends the Ethernet packet sent by the WIFI controller to the PC1 according to the matched forwarding entry.

The third packet forwarding manner is an implementation process of forwarding a packet by a first controller to a second controller.

A controller includes a first controller and a second controller, where the first controller is connected to a user-side interface of a first protocol, and the second controller is connected to a user-side interface of a second protocol; and the first protocol is a USB protocol, and the second protocol is a wireless communications protocol, or the first protocol is a wireless communications protocol, and the second protocol is a USB protocol. The packet forwarding method includes:

performing, by the first controller, Ethernet protocol conversion on a packet sent by the user-side interface of the first protocol, and sending a converted packet to the forwarding module; and

matching, by the forwarding module, a corresponding forwarding entry according to an Ethernet packet sent by the first controller, and encapsulating, according to the matched forwarding entry, the Ethernet packet sent by the first controller, and sending an encapsulated Ethernet packet to the virtual device controller;

receiving, by the virtual device controller, encapsulation information of the Ethernet packet sent by the forwarding module, and forwarding the Ethernet packet sent by the forwarding module to the second controller; and

performing, by the second controller, protocol conversion on the Ethernet packet sent by the virtual device controller, and sending a converted packet to the user-side interface of the second protocol.

Refer to FIG. 6. A structure of forwarding a packet to WIFI from a USB is used as an example. In a specific implementation process, a PC1 is accessed by using an Ethernet cable, a PC2 is accessed in a wireless mode, and a PC3 is accessed by using a USB cable. If a first protocol is a USB protocol and a second protocol is a wireless communications protocol, a first controller is specifically a USB controller connected to a user-side interface of the USB protocol, and a second controller is specifically a WIFI controller connected to a user-side interface of the wireless communications protocol. The PC3 sends a packet to the PC2. First, the USB controller parses the USB protocol, converts it into an Ethernet protocol, and transfers the Ethernet protocol to a forwarding module; the forwarding module searches a configured forwarding entry, and knows by matching that the packet needs to be sent to the PC2; the forwarding module configures and edits the packet according to the entry, and then transfers the packet to a virtual device controller; the virtual device controller extracts the packet, and invokes a WIFI controller transmission interface; and the WIFI controller sends the packet to the PC2.

In another embodiment of the present invention, the controller and the forwarding module communicate by using the Ethernet protocol or a proprietary protocol; and the forwarding module and the virtual controller communicate by using the Ethernet protocol. Refer to FIG. 7. In a specific implementation process, a PC1 is accessed by using an Ethernet cable, and a packet is converted into a proprietary protocol packet by an ETH controller. A PC2 is accessed in a wireless mode, and a packet is converted by a WIFI controller into a proprietary protocol packet by using the IEEE802.11x link protocol. A PC3 is accessed by using a USB cable, and a packet is converted by a USB controller into a proprietary protocol packet by using a USB link protocol.

In another embodiment of the present invention, the controller is a virtual controller, that is, the controller is a controller virtualized by using bottom-layer driver software; or the controller is a logical circuit, that is, the ETH controller, the WIFI controller, and the USB controller may also be implemented by hardware only.

By using one or more embodiments of the present invention, the following technical effects may be implemented:

In the present invention, a forwarding module is added between WIFI controllers or between USB controllers in an original architecture forwarding process. This module is implemented by hardware, has a forwarding entry, parses a packet according to a standard TCP/IP protocol, and then performs operations or actions such as editing, copying, discarding, and forwarding on the packet. Content of the forwarding entry is learnt by a Linux network protocol stack from an initial packet sent by the WIFI controller or the USB controller, and then a related rule is configured in the forwarding module; then, a subsequent packet from the WIFI controller or the USB controller is directly forwarded by the forwarding module. This packet forwarding method improves forwarding performance compared with the prior art.

Further, a packet sent from the controller to the Ethernet can be directly forwarded by the forwarding module to an Ethernet port, thereby reducing resources consumed by a CPU in parsing a packet, and improving forwarding efficiency. Similarly, for a packet sent from the Ethernet to the controller, the forwarding module obtains egress destination device information, completes encapsulation of a related packet, and then sends an encapsulated packet to the virtual device controller; after extracting the packet, the virtual device controller sends the packet to the controller directly according to the egress destination device information. In this way, the CPU does not need to parse and process the packet, which also optimizes the original forwarding process greatly and achieves a purpose of fast forwarding.

A person skilled in the art should understand that the embodiments of the present invention may be provided as a method, a system, or a computer program product. Therefore, the present invention may use a form of hardware only embodiments, software only embodiments, or embodiments with a combination of software and hardware Moreover, the present invention may use a form of a computer program product that is implemented on one or more computer-usable storage media (including but not limited to a disk memory, a CD-ROM, an optical memory, and the like) that include computer usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams. These computer program instructions may also be loaded onto a computer or another programmable data processing device, so that a series of operations and steps are performed on the computer or the other programmable device, thereby generating computer-implemented processing. Therefore, the instructions executed on the computer or the other programmable devices provide steps for implementing a specific function in one or more processes in the flowcharts and/or in one or more blocks in the block diagrams. Obviously, a person skilled in the art can make various modifications and variations to the present invention without departing from the spirit and scope of the present invention. The present invention is intended to cover these modifications and variations provided that they fall within the scope of protection defined by the following claims and their equivalent technologies.

What is claimed is:

1. A network access device, wherein the network access device provides user-side interfaces of at least two protocols and comprises: a controller corresponding to a protocol type of a user-side interface of the network access device, a protocol processing module corresponding to a protocol type of a network-side interface of the network access device, a forwarding module, and a virtual device controller, wherein the forwarding module is a logical circuit;
the controller is configured to perform protocol conversion on a packet sent by the user-side interface, and send a converted packet to the forwarding module; and perform protocol conversion on a packet sent by the forwarding module, and send a converted packet to the user-side interface;
the forwarding module is configured to match a corresponding forwarding entry according to the packet sent by the controller, and forward the packet to an Ethernet user-side interface according to the matched forwarding entry; or match a corresponding forwarding entry according to a packet sent by an Ethernet user-side interface or the packet sent by the controller, encapsulate, according to the matched forwarding entry, the packet sent by the Ethernet user-side interface or the packet sent by the controller, and send an encapsulated packet to the virtual device controller;
the virtual device controller is configured to forward, according to encapsulation information of the packet sent by the forwarding module, the packet sent by the forwarding module to a corresponding controller or the protocol processing module; and
the protocol processing module is configured to send the packet sent by the virtual device controller to the network-side interface.

2. The device according to claim 1, wherein:
the forwarding module is specifically configured to modify a destination address of the packet sent by the controller.

3. The device according to claim 1, wherein:
the forwarding module is specifically configured to: if the corresponding forwarding entry is not matched, forward the packet sent by the controller to the virtual device controller, so that the virtual device controller forwards the packet and delivers the forwarding entry corresponding to the packet to the forwarding module.

4. The device according to claim 1, wherein the controller comprises a first controller, wherein the first controller is connected to a user-side interface of a first protocol, and the first protocol is a USB protocol or a wireless communications protocol;
the forwarding module is specifically configured to: after an Ethernet packet, which is sent to a user equipment connected to the user-side interface of the first protocol, is received from the Ethernet user-side interface, match a corresponding forwarding entry according to the Ethernet packet, update a destination address of the Ethernet packet to an address of the first controller according to the matched forwarding entry, and forward the Ethernet packet with the destination address updated to the virtual device controller;
the virtual device controller is specifically configured to forward the Ethernet packet with the destination address updated to the first controller; and
the first controller is specifically configured to convert the Ethernet packet with the destination address updated into a first protocol packet, and send, through the user-side interface of the first protocol, the first protocol packet to the user equipment connected to the user-side interface of the first protocol.

5. The device according to claim 1, wherein the controller comprises a first controller, wherein the first controller is connected to a user-side interface of a first protocol, and the first protocol is a USB protocol or a wireless communications protocol;
the first controller is specifically configured to perform Ethernet protocol conversion on a packet sent by the user-side interface of the first protocol, and send a converted packet to the forwarding module; and
the forwarding module is specifically configured to match a corresponding forwarding entry according to an Ethernet packet sent by the first controller, and when the Ethernet user-side interface is matched, send the Ethernet packet sent by the first controller to the Ethernet user-side interface according to the matched forwarding entry.

6. The device according to claim 1, wherein the controller comprises a first controller and a second controller, wherein the first controller is connected to a user-side interface of a first protocol, and the second controller is connected to a user-side interface of a second protocol; and the first protocol is a USB protocol, and the second protocol is a wireless communications protocol, or the first protocol is a wireless communications protocol, and the second protocol is a USB protocol;
the first controller is specifically configured to perform Ethernet protocol conversion on a packet sent by the user-side interface of the first protocol, and send a converted packet to the forwarding module;
the forwarding module is specifically configured to match a corresponding forwarding entry according to an Ethernet packet sent by the first controller, and encapsulate, according to the matched forwarding entry, the Ethernet packet sent by the first controller, and send an encapsulated Ethernet packet to the virtual device controller;
the virtual device controller is specifically configured to receive encapsulation information of the Ethernet packet sent by the forwarding module, and forward the Ethernet packet sent by the forwarding module to the second controller; and
the second controller is specifically configured to perform protocol conversion on the Ethernet packet sent by the virtual device controller, and send a converted packet to the user-side interface of the second protocol.

7. The device according to claim 1, wherein:
the controller and the forwarding module communicate by using an Ethernet protocol or a proprietary protocol; and
the forwarding module and the virtual controller communicate by using the Ethernet protocol.

8. The device according to claim 1, wherein the controller is a virtual controller, or the controller is a logical circuit.

9. A packet forwarding method, applied to a network access device, wherein the network access device provides user-side interfaces of at least two protocols and comprises: a controller corresponding to a protocol type of a user-side interface of the network access device, a protocol processing module corresponding to a protocol type of a network-side interface of the network access device, a forwarding module, and a virtual device controller, wherein the forwarding module is a logical circuit; and the method comprises:
performing, by the controller, protocol conversion on a packet sent by the user-side interface, and sending a converted packet to the forwarding module; and performing protocol conversion on a packet sent by the forwarding module, and sending a converted packet to the user-side interface;
matching, by the forwarding module, a corresponding forwarding entry according to the packet sent by the controller, and forwarding the packet to an Ethernet user-side interface according to the matched forwarding entry; or matching a corresponding forwarding entry according to a packet sent by an Ethernet user-side interface or the packet sent by the controller, encapsulating, according to the matched forwarding entry, the packet sent by the Ethernet user-side interface or the packet sent by the controller, and sending an encapsulated packet to the virtual device controller;
forwarding, by the virtual device controller, according to encapsulation information of the packet sent by the forwarding module, the packet sent by the forwarding module to a corresponding controller or the protocol processing module; and
sending, by the protocol processing module, the packet sent by the virtual device controller to the network-side interface.

10. The method according to claim 9, wherein the encapsulating, according to the matched forwarding entry, the packet sent by the controller is specifically:
modifying, by the forwarding module, a destination address of the packet sent by the controller.

11. The method according to claim 9, further comprising:
if the corresponding forwarding entry is not matched, forwarding, by the forwarding module, the packet sent by the controller to the virtual device controller, so that the virtual device controller forwards the packet and delivers the forwarding entry corresponding to the packet to the forwarding module.

12. The method according to claim 9, wherein the controller comprises a first controller, wherein the first controller is connected to a user-side interface of a first protocol, and the first protocol is a USB protocol or a wireless communications protocol; and the method further comprises:
after receiving, from the Ethernet user-side interface, an Ethernet packet, which is sent to a user equipment connected to the user-side interface of the first protocol, matching, by the forwarding module, a corresponding forwarding entry according to the Ethernet packet, updating a destination address of the Ethernet packet to an address of the first controller according to the matched forwarding entry, and forwarding the Ethernet packet with the destination address updated to the virtual device controller;
forwarding, by the virtual device controller, the Ethernet packet with the destination address updated to the first controller; and
converting, by the first controller, the Ethernet packet with the destination address updated into a first protocol packet, and sending, through the user-side interface of the first protocol, the first protocol packet to the user equipment connected to the user-side interface of the first protocol.

13. The method according to claim 9, wherein the controller comprises a first controller, wherein the first controller is connected to a user-side interface of a first protocol, and the first protocol is a USB protocol or a wireless communications protocol; and the method further comprises:
performing, by the first controller, Ethernet protocol conversion on a packet sent by the user-side interface of the first protocol, and sending a converted packet to the forwarding module; and
matching, by the forwarding module, a corresponding forwarding entry according to an Ethernet packet sent by the first controller, and when the Ethernet user-side interface is matched, sending the Ethernet packet sent by the first controller to the Ethernet user-side interface according to the matched forwarding entry.

14. The method according to claim 9, wherein the controller comprises a first controller and a second controller, wherein the first controller is connected to a user-side interface of a first protocol, and the second controller is connected to a user-side interface of a second protocol; and the first protocol is a USB protocol, and the second protocol is a wireless communications protocol, or the first protocol is a wireless communications protocol, and the second protocol is a USB protocol; and the method further comprises:
performing, by the first controller, Ethernet protocol conversion on a packet sent by the user-side interface of the first protocol, and sending a converted packet to the forwarding module; and
matching, by the forwarding module, a corresponding forwarding entry according to an Ethernet packet sent by the first controller, and encapsulating, according to the matched forwarding entry, the Ethernet packet sent by the first controller, and sending an encapsulated Ethernet packet to the virtual device controller;
receiving, by the virtual device controller, encapsulation information of the Ethernet packet sent by the forwarding module, and forwarding the Ethernet packet sent by the forwarding module to the second controller; and
performing, by the second controller, protocol conversion on the Ethernet packet sent by the virtual device controller, and sending a converted packet to the user-side interface of the second protocol.

15. The method according to claim 9, wherein:
the controller and the forwarding module communicate by using an Ethernet protocol or a proprietary protocol; and
the forwarding module and the virtual controller communicate by using the Ethernet protocol.

16. The method according to claim 9, wherein the controller is a virtual controller, or the controller is a logical circuit.
